(19) United States
(12) Patent Application Publication
(10) Pub. No.: US 2006/0294396 A1
(43) Pub. Date: Dec. 28, 2006

(54) Multiplatform synchronized data access from mobile devices of dynamically aggregated content

(76) Inventors: Robert Witman, Pasadena, CA (US); Jeffrey Baitis, San Gabriel, CA (US); Theodore Witkamp, San Gabriel, CA (US)

Correspondence Address: Robert Witman, 107 S. Holliston Ave #308, Pasadena, CA, 91106, US

(21) Appl. No.: 11/475,297

(22) Filed: Jun. 26, 2006

Related U.S. Application Data
(60) Provisional application No. 60/693,707, filed on Jun. 24, 2005.

(51) Int. Cl. G06F 12/14

(52) U.S. Cl. 713/189

(57) ABSTRACT

A system and method for accessing information with an embedded device comprising an aggregator for gathering information desired by the user, and an embedded device capable of downloading the information gathered by the aggregator, wherein the system maintains synchronization between the aggregator and the embedded device.

### CROSS-REFERENCE TO RELATED APPLICATIONS

This application claims priority benefits of provisional application Ser. No. 60/693,707, filed on Jun. 24, 2005, entitled “Multiplatform Synchronized Data Access from Mobile Devices of Dynamically Aggregated Content”, the entire contents of the provisional application are incorporated herein by reference.

### FIELD

The present invention relates generally to a system and method for accessing aggregated information using a mobile device and, more particularly, relates to a system and method for facilitating a synchronized user experience between the standard interface of an aggregation device and a remote client running on an embedded mobile platform, such as a cell phone.

### BACKGROUND

An aggregator refers to any system found in a computing environment that acquires externally produced information predetermined by a user, monitors changes of the information content and updates itself when the information has changed in some way. FIG. 1 shows an example of one such aggregator 3 (or aggregation engine), within the context of the Internet. This aggregator may be a server-based piece of software accessible from an Internet browser 4, as shown in FIG. 1. Alternatively, this aggregator may reside on a user's desktop. In either case, the aggregator provides the infrastructure for tracking and maintaining the most current, unread information produced by the user selected sources.

Recent advances in information aggregation have changed how users interact with information portals, such as the Internet. Many of these aggregators make use of a common mark up language called RSS, or ‘Really Simple Syndication,’ to provide users with the latest information from various sites. These aggregators have been established to retrieve and monitor external information sources and then funnel those data back to the user. Typically, the data are returned to users using either a standard web browser, or in some cases, the aggregator has been incorporated into other commonly used applications such as Microsoft Outlook.

To make use of this new paradigm in information management, users log into online aggregators, such as Bloglines or NewsGator, and subscribe to various other websites with continually changing content, such as personal blogs or other mainstream news sites. The aggregator then checks these sites periodically and provides users with a single online site to monitor updates to all of the sites previously registered with the aggregator. This allows users to efficiently monitor a large variety of pre-selected information of their choice. By only displaying the information that a user has placed a priority on, and keeping track of what the user has already read, the user is able to much more quickly filter through the vast amounts of data being generated online.

What is missing from this current model is mobile access to this information. The above paradigm assumes that the user is able to reach the Internet portal through a website via a computer with access to the Internet. The present invention relates to a system and method for not only obtaining this information remotely, but also synchronizing it with the web based aggregator. Various other devices are able to sync their mobile data sets, such as address books or notes, but none have attempted to synchronize dynamic web-based content and provide it on a mobile platform.

One method of addressing this issue has been attempted by NewsGator and their WAP version of the aggregator. WAP, or Wireless Application Protocol, is a specification for creating special web pages especially for viewing on mobile devices. NewsGator has reworked their host website to allow for a mobile device to run the host application remotely. The described WAP portal requires a significant amount of processing power along with a large screen on which to display the retrieved data. These attributes are typically only available on ‘SmartPhones’ or other high end PDAs and wireless devices. As such, this method of access is not practical for the large majority of low cost, low power mobile devices that make up the bulk of the mobile phone market today.

Another approach has been demonstrated by FreeRange Communications. This approach limits the entire aggregation experience to the mobile device itself. All of the interaction must be done with the mobile device, selection of feeds, reading of feeds, sending to friends, etc. This does not require synchronization as there is only one device in the process. However, this severely limits the breadth of the utility of the application as the information is not portable. A user is constrained to only view the information using their cell phone. Should a user attempt to view content that is not able to fit on the phone, or is not available for another reason, they cannot revisit that content with a more capable device (such as a computer) at a later time without manually searching for it.

### SUMMARY

The present invention relates to a system and method for accessing from a mobile embedded device, information gathered by an aggregator, while keeping track of information that has already been accessed by the user and thereby maintaining consistency between the information shown as new on the embedded device and the information shown as new by the aggregator.

The system in accordance with the present invention comprises an embedded mobile device for accessing the desired information, an internet based aggregator or host aggregator to collect information of interest from the World Wide Web, an embedded application module (EAM) residing on the embedded device to communicate with the host aggregator, receive information, format the information and display it on the embedded device, an API residing on the aggregator to communicate with the EAM and provide an interface between the EAM and the host aggregator, and a set of synchronization rules implemented by both the EAM and the API to allow the system to maintain consistency between the information shown as new on the embedded device and the information shown as new by the aggregator.

A device, system and method for accessing and synchronizing dynamically changing aggregated content originating from a third party source with a mobile embedded device is disclosed. The embedded device may have limited capability (e.g., basic cellular phone). The method preferably includes implementing a standard communication protocol and API running on the aggregator. A complimentary piece of software, an EAM, resides on the mobile embedded device. This EAM conforms to the API set out by the aggregator, as well as provides a means for display of information retrieved by the embedded device. A synchronization methodology is presented in the API to allow the mobile embedded device to interact with the main aggregator. In this manner, the mobile user is able to pass between the traditional aggregator interface found on the Internet, to the mobile one and vise versa without having to manually indicate what has been viewed on either system, thus being presented with unread information only, regardless of how the information is accessed (i.e., using a standard Internet browser or using a mobile embedded device). Both interfaces also allow for storage of the content should the user decide to maintain it for future reference.

A preferred embodiment of the device, system, and method, in accordance with the present invention, includes a web based content aggregator, such as Bloglines or NewsGator, a device accessible API to be run on said aggregator, a common interface protocol (such as XML), a synchronization framework and a mobile embedded device, such as a cell phone or PDA that has a means of connection to a network, such as the Internet or other. The first step is taken by the mobile device querying the host aggregator for the user's current feed state. Once this state has been queried by the mobile device, it then preferably uses the API to pull the desired content from the web based aggregator. In this manner, the web based aggregator is kept apprised of the mobile client's actions. Finally, a user is able to indicate to the aggregator, through the mobile device, various other actions and options that may be applied once the content has been read. These actions may include, but are not limited to, keeping information as new or unread, sending a notice to another user, saving the notice for review at a later time, clipping the notice and placing it on the user's blog, etc.

### FEATURES AND ADVANTAGES

This invention does not require the aggregator application to be loaded onto the mobile device, as prior solutions have done (such as NewsGator's WAP interface), rather, it relies on a simple set of APIs to obtain, from the aggregator, the current state of the remote content. This limits the amount of bandwidth consumed by the application. This also allows for the application presented on the mobile device to be specially formatted and sized to the mobile environment. This contrasts with attempting to run a host application designed for a more capable and viewable screen such as a laptop or desktop monitor.

By limiting the amount of information transferred between the host and client, the client software (e.g., EAM) can be made to operate in a constrained embedded environment. This is crucial as the hardware found in most mobile devices is far less capable than that found in a standard computing environment. In addition, the display capabilities are very limited and confining. In accordance with the present invention, information display is designed to specifically deal with the display limitations and requirements imposed by the embedded environment.

The present invention has synchronization capabilities as all requests are made through the host aggregator. By interacting with the host aggregator in a similar manner to the native web interface, the back end software continually stays apprised of the user states generated by the front end application, whether it is found on a standard computer or a more constrained embedded device such as a mobile phone or PDA.

The implementation of the present invention requires minimal adjustment to the host aggregator. The API in accordance with the present invention provides a way to interface with the host aggregator that can be used by any external source including a desktop computer, or an embedded device, such as a mobile phone.

The present invention does not require the embedded device to have been enabled for Internet browsing via a WAP server typically residing on a phone carrier's servers. This service is charged to the customer and provides rudimentary and quite poor conversion of normal HTML websites to a form viewable on the phone. However, this paid service does not work for the majority of websites, and does not work well on sites that it is able to display. Still, the service is a fee based one. The current embodiment does NOT require a subscription to a WAP service; instead, the present invention can connect via a direct or indirect data connection to the host aggregator, or to specific feed sites hosted on the web. Utilizing the IP address of the aggregator on the Internet and making calls to that address would be an example of direct connection, whereas connecting to a proxy server first which would then make the connection would be an example of an indirect connection.

### BRIEF DESCRIPTION OF THE DRAWINGS

FIG. 1 is a schematic diagram showing a server-based aggregator wherein the aggregator is accessed using a web browser in accordance with the present invention.

FIG. 2 is a schematic diagram showing a server-based aggregator wherein the aggregator is accessed using an embedded device in accordance with the present invention.

FIG. 3 is a schematic diagram showing certain components of the Embedded Application Module (EAM) in accordance with the present invention.

FIG. 4 is a schematic diagram showing an example of a system flowchart in accordance with the present invention.

FIG. 5 represents screen shots of the embedded device showing examples of the information displayed on the screen of the embedded device after certain actions after certain steps are taken in accordance with the present invention.

### DETAILED DESCRIPTION

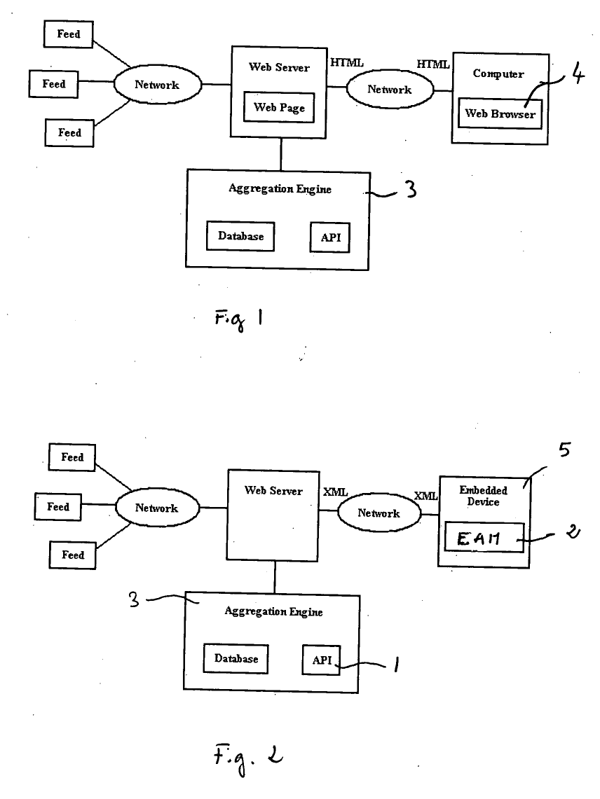

This invention makes use of an already present feed aggregator such as Bloglines or NewsGator. Once a user has a valid account with an aggregator, they can utilize the present invention to expand their aggregation activities to various embedded mobile devices such as cell phones or PDAs. FIG. 1 shows a configuration where the user accesses the aggregator 3 from a web browser 4 on a computer, whereas FIG. 2 shows the same aggregator being accessed by an embedded device 5. In short, the present invention enables users to access with their mobile device the same information they would normally obtain online by visiting their favorite aggregator using a web browser. Once the desired information had been accessed and/or read by the user on the mobile device, the online aggregator is preferably updated so as to no longer show the information read on the mobile device as new information. This being said, the user has the option to keep this already read information as new. In this case, the online aggregator is not updated and the next time the user accesses the aggregator, either online or from the mobile device, this information will appear as though it was never read by the user. Whether the user accesses the aggregator online from his/her computer or from his/her mobile device, in the preferred embodiment, the present invention keeps track of the information that the user has already accessed and does not present the same information again to the user (unless the user indicates that he/she wishes to see the same information again).

In a preferred embodiment, the aggregator maintains an active list of feeds, or ‘feed list’ that a user monitors. Feeds are defined as websites that occasionally post new data to the site and tag this data with a date. A feed includes the URL, the author, a title, a unique identifier and other pertinent information specific to that feed. In a preferred embodiment feeds conform to the RSS 1.0 specification or later. This ensures that new posts are properly monitored and tracked based on their title and date. Feed lists may include extra user specific information such as the user name of the individual, the number of posts that have not been read or other content specific data.

In a preferred embodiment, new posts within feeds are referred to as ‘items’. Items include a date, a title, author, text, pictures, sounds, a rating or other information associated with the information contained within. In addition to the already included unique data, the aggregator may choose to add a separate identifier to each unique item. This identifier can take the form of a unique number, a sequence of characters or any other identifier common in the art. This unique identifier can be used to direct item specific actions, such as saving or sending, without changing the status of other items or the entire feed.

It is assumed that the wireless embedded device used to access the information desired by the user has an indirect or direct Internet connection with which to connect to the aggregator's main website. However, the present invention does not require the embedded device to have been enabled for Internet browsing via a WAP server which typically resides on a phone carrier's servers, and for which the phone carrier charges the user. Instead, a preferred embodiment utilizes, but is not limited to, the phone network to access the Internet, without the need for a browser or WAP portal. The architecture also preferably allows for handshaking of the user's login and password, which can be stored on the embedded device.

The first step in creating a synchronized client of the host is to have the EAM (on the embedded device) query the host aggregator for the list of feeds that the user subscribes to. These data can be transmitted using standard HTML, XML or other files common in the art to allow for consistent behavior across a variety of platforms, or can be transmitted in any other way known in the art. In a preferred embodiment, this list of feeds also contains the number of unread items in each feed. Alternatively, the system may have to request the number of unread items in each feed separately. Once the list of feeds with corresponding number of unread items has been retrieved, the system is ready to retrieve specific feeds and their included items at the user's request.

In a preferred embodiment, when a user requests a particular feed after selecting it from the feed list, all of the associated unread items within that feed are downloaded and parsed by the embedded mobile device and the list of unread item titles is displayed to the user. Alternatively, using this ID or distinguishing marker, the embedded device may query the host aggregator for an individual item in question.

As in the web based system (i.e., accessing the aggregator on the web with a computer), the system of the present invention relies on the host aggregator to pull in feeds and associated items from external web sites. Since the feeds and items are requested by the mobile device from the host aggregator, the host aggregator is able to keep track of the feeds/items downloaded by the mobile device and is, in turn, able to update the status of the items gathered by the host aggregator, from “unread” status to “read” status. The transition from “unread” to “read” can be initiated by the act of the embedded device downloading a feed or an item. Alternatively a signal can be sent from the embedded device to the aggregator, instructing it to change the status from “unread” to “read,” or from “read” to “unread”. In different embodiments or settings of the present invention, this signal can be sent automatically when a new item is opened by the user on the embedded device, or when an item is closed by the user on the embedded device, or when the user uses the option offered by the EAM to mark the item as “read”.

On the mobile device, the user may have the option of marking any downloaded item as “unread”. When an item is marked as “unread”, the item is presented as a new item the next time the user accesses the aggregator. This holds true whether the user accesses the aggregator from the mobile device or online from a computer. This information instructing the host aggregator to mark an item as “unread” even though the item had been downloaded from the host aggregator is preferably transmitted from the embedded platform to the host aggregator using the previously mentioned TCP/IP connection or other suitable connection common in the art. The exact timing and rules followed to mark items as “read” and “unread” can be presented to the user as an option beyond providing a single function.

In another embodiment of this invention, an assumption or “rule” is made that a user has not read an item until they have actually indicated so on the embedded platform. This requires slightly more user intervention, but could be desirable for certain applications of the technology. Alternatively the application could operate under the rule that all items within a downloaded feed are “read”.

In a preferred embodiment, the host aggregator does not change the status of items that have been downloaded by the mobile device to a “read” status until it receives confirmation from the mobile device that the item has been opened by the user. In this case, once the user opens the item for display on the mobile device, the mobile device sends back information to the host aggregator instructing it to change the status of the item from “unread” to “read”. Multiple “read” status messages can be queued for more efficient operation in a low bandwidth or limited bandwidth situation.

By implementing the above query and handshaking methods, the embedded mobile device can maintain synchronization with the host aggregator typically accessed via a web page. In this way, the host aggregator continually keeps track of the user's actions and those of the target websites and web logs and thus maintains a synchronized data set across the entire set of devices and portals. Should the user cease using the embedded device and begin using a traditional, full featured computer, the system will not show the user items that have been previously read (or marked as “read”) using the embedded device. Alternatively, if the user moves from the traditional, full featured computer to an embedded system, the embedded device will not display items that have been read earlier on the full featured computer. However, in both of these scenarios, should the content being viewed change (a new post is made to a blog, or a news story is broken and posted on a website) the user will have immediate access to this new piece of information from both the embedded device and a full features computer.

The main components of the system and method in accordance with the present invention are: 1) an embedded application module (EAM) residing on the embedded device, 2) an API residing on the aggregator and 3) a set of synchronization rules including an event based update model on the embedded device notifying the aggregator of its actions. Because all of the data are brought through the host aggregator, independent of the final destination, this model utilizes the least amount of extra software and effort. However, other embodiments could route data directly from the source of the feeds to the embedded device and choose to only send information relating to ‘read’ status to the host aggregator. The following sections describe the main components of the invention in detail.

I—Embedded Application Module (EAM)

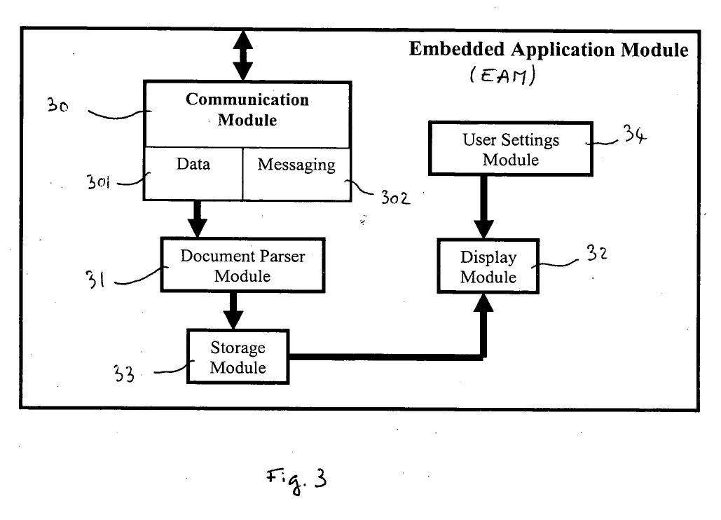

The EAM is preferably implemented in software running on the embedded device and its main components are shown in FIG. 3. However, any way known in the art of executing the steps of the method associated with the EAM is within the scope of the present invention. Some of the EAM main functions are to manage communication between the embedded device and a host, and allow a user to view, with the embedded device, up to date information gathered by the host. In the preferred embodiment the host is a web aggregator and information is communicated through the Internet.

In order to achieve the above functionality, the EAM preferably includes the following modules: a communications module 30, a document parser 31 relating to a certain specification, a display module 32, a storage module 33, a user settings module 34.

Communication Module

The communication module 30 includes two components: 1) the data communication module 301; and 2) the messaging communication module 302:
1. The data communication module 301 manages communication between the embedded device and the host aggregator. The data communication module preferably communicates in the standard form found on the network accessible to the embedded device. In the preferred embodiment, the communication module transfers information in the form of Internet Protocol, or IP, packets commonly found in devices that communicate via a network, such as the Internet. The communication module includes functions for both sending and receiving of data. It is desirable, but not necessary, for the communication module to also have a method of communicating its status to the rest of the application. This is helpful in passing the state of the communication to the other application modules as well as to the user.
2. The messaging communication module 302 manages communication between the embedded device and other devices. The messaging communication module is capable of transmitting information via “Short Message Service”, SMS, or “Simple Mail Transfer Protocol”, SMTP or other methods common in the art. The SMS messages sent by the module may be encoded to provide enhanced functionality. Should a device that is running the EAM receive an encoded SMS from the messaging module of another device, the encoded portion of the message can be used to trigger the device's EAM to boot up if it is not already active. Once it has booted, the rest of the information found in the message can be used by the EAM to retrieve the feed/item of interest. Alternatively, if the receiving device does not already have the EAM, the message can display an advertisement to purchase the application. The messaging module is also capable of utilizing an external SMTP server to generate an email containing the item of interest.
   Document Parser Module

The information that is downloaded by the communication module 30, either from the host aggregator, or directly from a target website or blog, comes in a variety of document formats. The role of the document parser module 31 is to receive documents in various formats and to output pertinent data in a format usable by the other modules of the EAM and in particular the display module 32. The document parser module is able to handle many different document formats, including, but not limited to XML and HTML. In addition, the document parser module is able to handle malformed documents without adversely affecting the application. In a preferred embodiment, the document parser generates item structures that include the title, text, graphics, author and other objects found within the items.

The document parser module includes a rules engine that manages the creation of useful data as a document is scanned by the document parser module. This engine sorts through the incoming document and is able to keep track of ‘tags’ inside of the document that identify content specific data. As it scans through a document and finds a tag for the text or body of the document, it then stores that information as the text of the particular item that it is parsing. Similar tags may indicate but are not limited to feeds, formatting, and enclosures. All tags are handled in some manner and many tags provide insight into a particular attribute of the document and its associated text. A preferred embodiment is capable of handling tags from HTML, XML and RSS standards and utilizes a ‘push’ style of information retrieval.

Display Module

The role of the display module 32 is to effectively display to the user the information that has been downloaded by the communication module and processed by the document parser module. To do so the display module formats the received data into a format suitable to the available screen. This display module is able to accept a wide variety of inputs and properly assign to each input a suitable location on the screen. Such location will depend on the content that is being viewed by the user at that time. In addition, the display module is also responsible for painting the actual display to the embedded device's screen. Finally the display module handles several features related to the look and appearance of the display.

Storage Module

One of the significant challenges in the development of applications for embedded devices is that the physical memory available for program execution is relatively small. As a result, it is sometimes necessary to store data into the file system. However, accessing the file system is time consuming. In a preferred embodiment of the storage module 33, the cached file system is used for reading and writing data. This minimizes both the required program execution space, as well as the amount of time spent retrieving information from the file system. The result is an application that is capable of dealing with relatively large documents in a constrained environment such as a mobile phone or other embedded device.

User Settings Module

The user settings module 34, while providing much convenience to the user, may or may not be included in the system and method of the present invention. However, in a preferred embodiment of the present invention, the user settings module is included as it provides many useful and persistent options to the user. This module is responsible for saving and recovering all of the user's desired application settings. These settings include, but are not limited to, the login and password to the host aggregator, the desired font size for rendering information, default “read” behavior, etc. The information stored in the user settings module is used throughout the application and stored on the file system for the next use, avoiding the need for the user to re-enter this information each time they enter the application.

II—API

A preferred embodiment of the system and method of the present invention also comprises an externally accessible API 1 running on the host device and in particular a host aggregator or aggregation engine 3. The API can be accessible through a variety of connectivity means, such as, but not limited to, a proprietary data packet sent over TCP/IP, or more simply, a standard XML document containing the function parameters and arguments. The data returned in response to API calls does not necessarily need to be in the same format as the API call itself. In a preferred embodiment, the data returned, in this case feeds, feed lists, items etc, are returned in their native format, which includes XML or HTML.

In a preferred embodiment, the API carries out the following functions:

1. User Authentication
This function handles the authentication of a particular user with the host aggregator. It requires the user to input authentication information (such as username and password) into the embedded device and then transfers this information to the host aggregator. Once this function has been successfully executed, future calls from the embedded device are assumed to originate from the user previously authenticated. Alternatively, in a preferred embodiment, the user authentication information is included in each of the functions described below. This removes any ambiguity as to the user's data.

2. Query of Feeds
When called, this function returns to the embedded device a list of the managed feeds and feed status, and any associated feed attributes. Attributes may include, but are not limited to, the name of the feed, the hyperlink to the actual feed, the number of unread items, etc

3. Query of Feeds with unread items
This function is similar to the above function except that it only returns feeds that contain unread items (i.e., feeds for which the number of unread items is greater than 0).

4. Retrieve Feed
This function returns an actual feed, specified by the argument to the API call, with all of the associated unread items and their individual data to the EAM. Each item's data may contain a title, associated text and other objects such as, but not limited to graphics or hyperlinks.

5. Retrieve Item
This function returns an individual item, specified by the argument to the API call. The argument may indicate the associated upper level feed, along with the unique ID used to identify the item itself. The item's data may contain a title, associated text and other objects such as, but not limited to graphics or hyperlinks.

6. Mark items as ‘read’
This function allows the embedded device to notify the host aggregator that a user has ‘read’ an item and no longer needs to see this item the next time the user accesses the aggregator, either directly or with the embedded device. To facilitate the correct identification of the item in question, an embodiment of this function utilizes an MD5 hash, 128 bit uniquely identifying number generated from the actual content, or similar non-intersecting algorithm to uniquely identify the item in question. Alternatively, the host aggregator assigns to the item a unique ID that is then stored on the embedded device and used when communicating with the aggregator.

7. Mark items as ‘unread’
This function allows the embedded device to notify the host feed aggregator that a user desires to leave an item as ‘unread’, even though he may have read the item on the embedded device. This is particularly useful in the embodiment where the default behavior is to mark all of the downloaded items ‘read’ with the assumption that if they were downloaded, they were read. Alternatively, a user may begin to read an item (potentially triggering an instruction to mark the item as read) and not be able to finish it. In this case, the user would be able to undo the ‘read’ notification and leave the item with an “unread” status so that the item can be viewed at a later time.

8. Mark feeds as ‘read’
This function notifies the host aggregator that a user has read all of the items in a particular feed. This may be used to minimize bandwidth between the embedded device and the host aggregator.

9. Mark feeds as ‘unread’
This function notifies the host feed aggregator that a user has not read any of the items in a particular feed.

The previously described API can be reduced in its scope by assuming certain behaviors result in a specified state change. For instance, the system may be made to function such that when a user downloads the items relating to a particular feed, these items are automatically marked as read on the host aggregator. In this manner, the API function described above to mark specific items as read, along with the function to mark specific feeds as read may not be required. This would also decrease the amount of communication required between the embedded device and the host aggregator.

III—Synchronization Rules Module

The synchronization rules are created to facilitate more efficient use of bandwidth in a constrained mobile embedded environment. In this particular application, the synchronization rules preferably focus on the “read” status of feeds and items within those feeds. To limit the number of messages that must travel over the network to the host aggregator, rules are applied that result in default behavior and state status. In the preferred embodiment, the host aggregator assumes that the user has not read an item until the EAM has indicated so via the API. However, to conserve bandwidth, another embodiment of the rules could assume that if a feed and its associated items had been downloaded, this information was then “read”. This would eliminate the need for the EAM to send information at a later date indicating that the user had in fact “read” the downloaded material.

Another rule created for the mobile environment is the requirement of a manual download for requested data. Rather than downloading all of the unread items indicated by the aggregator, the EAM waits for the user to indicate exactly which feeds they would like to read. This limits the number of initial network traffic required to start the application and produces a more expedient startup for the application on the phone.

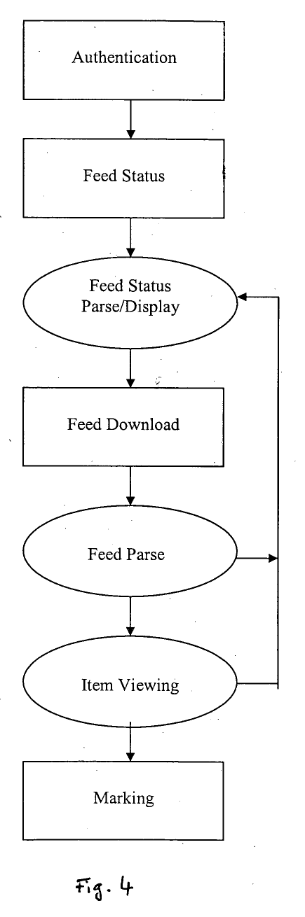

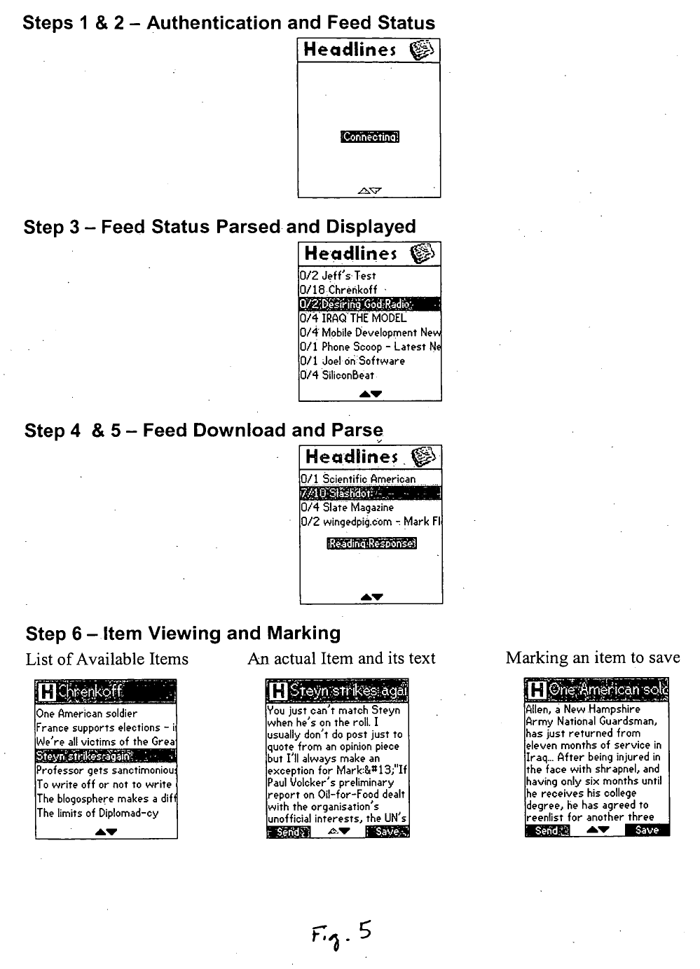

System Flow Chart (FIG. 4 and FIG. 5)

[Step 1—Authentication

To ensure a seamless user experience, it is desirable to check the user's authentication information prior to initiating the rest of the application. As such, once a user launches the EAM (residing on the embedded device), the first action taken is to test communication with the host aggregator. This is done by using the users' login information and attempting to query the host aggregator with one of the above functions of the API. Should the query fail, then either the login information is incorrect, or the host aggregator is unreachable, and the EAM then displays this information and takes corrective measure.

Step 2—Feed Status

With the validated login information, the EAM can now request the user's current feed list status. This is done through the API function ‘Query of Feeds’ or ‘Query of Feeds with unread items’ depending on the implementation. A preferred embodiment utilizes the ‘Query of Feeds with unread items’ to retrieve all of the user's currently monitored feeds with new “unread” update. The information is preferably sent to the embedded device in the form of a preformatted XML document, but could be any other generic data structure.

Step 3—Feed Parse and Display

In one embodiment, the EAM does not have targeted access to the unread feeds only. In this case, the EAM parses through the feed list information received from the host aggregator. As it parses the information, it stores the feeds with unread items in the application's memory. Should the API function ‘Query of Feeds with unread items’ be available, the above process is slightly more straightforward since in this case, the EAM receives only those feeds which include are new items. Once the feeds with unread items have been identified, the names and numbers of unread items are displayed to the screen for the user to read.

Step 4—Feed Download

Upon being presented with a list of feeds with the associated number of unread items, the interface of the EAM provides the user with the ability to select a certain feed. This selection then results in the sending of an API function call to retrieve the specified feed and its associated items. The feed's items may be returned to the EAM through the host aggregator, or the feed information may be used to request the feed directly from the actual feed's website. Either way, the host aggregator is made aware of the EAM's request of the feed via the API function call. This information may then be used to mark all of the downloaded items of the selected feed as ‘read’, should the implementation desire to follow the above mentioned convention for assuming that any item downloaded as been read.

Step 5—Feed Parsing

Once the data containing the feed and its associated items have been received by the EAM, it is preferably parsed for relevant information. The EAM may require a special parser, such as an XML parser, to be able to handle the information being transmitted to it. This parser takes the feed as its input, and produces structures for each of the associated bits of information found in the feed. In a preferred embodiment, the item information is stored in a linked list of ‘Item’ structures, with associated structures for the text and other included objects within the item.

Step 6—Item Viewing and Marking

When the items of a particular feed have been downloaded and parsed, they are displayed to the user on the embedded device's screen. Often, items have titles associated with them and in a preferred embodiment the display includes a list of the items downloaded using the items' titles. However, the list of items may be displayed in any other suitable way. When a user selects one of the items from the list, they are then presented with the underlying information included in the item. This may include, but is not limited to text, graphics, images, or hyperlinks. Depending on the overall architecture of the embodiment, the EAM may utilize the API function: ‘Mark item as ’ read” (as described above) to notify the host aggregator that the user has viewed the particular item selected. This maintains synchronization with the host aggregator and ensures that if the user stops using the embedded application and continues with the traditional web based application, they are not presented with items that they have already read using the embedded device. Alternatively, the user is presented with the option to keep a particular item with an ‘unread’ status through the API function: ‘Mark item as ’ unread”. This may be presented as an option to the user through the user interface so that should they desire to revisit the item, the host aggregator will keep the item's status as “unread” for next time, even though they have already read it.

FIG. 5 shows a practical example of the retrieval of information using an embedded device by showing exemplary screenshots displayed on the embedded device following certain steps undertaken by the system of the present invention.

Although the present invention has been described with reference to specific details of certain embodiments thereof, it is not intended that such details should be regarded as limitations upon the scope of the invention except as and to the extent they are included in the accompanying claims. Many modifications and variations are possible in light of the above disclosure and are within the scope of the present invention.

1. A system for accessing information with an embedded device, the system comprising:
a) an aggregator for gathering information desired by a user; and
b) an embedded device capable of downloading the information gathered by the aggregator;
Wherein,
the aggregator keeps track of information that is accessed by the user whether the information is accessed using the embedded device or using any other device.

2. The system of claim 1, wherein,
a) the information gathered by the aggregator has one of two states: “read” or “unread”; and
b) whenever the user instructs the embedded device to download information from the aggregator, only information having a state of “unread” is downloaded onto the embedded device.

3. The system of claim 2 wherein, whenever the embedded device downloads information from the aggregator, the aggregator switches the state of the downloaded information from “unread” to “read”.

4. The system of claim 2 wherein, whenever the user accesses information originating from the aggregator using the embedded device, the embedded device instructs the aggregator to switch the state of this information from “unread” to “read” on the aggregator.

5. The system of claim 4 wherein the user has the option to prevent the embedded device from instructing the aggregator to switch the sate of the information read by the user from “unread” to “read”, thereby maintaining the state of the information on the aggregator as “unread”.

6. The system of claim 2 wherein the information gathered by the aggregator includes feeds and wherein each feed includes at least one item.

7. The system of claim 6, wherein, when the user instructs the embedded device to obtain information gathered by the aggregator, the embedded device first queries the aggregator for the list of feeds containing unread items, and wherein, pursuant to the query, the aggregator returns the list of feeds containing unread items and the number of unread items within each feed.

8. The system of claim 7, wherein the embedded device then downloads the content of the unread items from the aggregator.

9. The system of claim 8, wherein, for each item downloaded by the embedded device, the aggregator switches the state of the item from “unread” to “read”.

10. The system of claim 8, wherein, whenever an item is opened by the user to be displayed on the embedded device, after the item is opened by the user, the embedded device sends instructions to the aggregator to switch the state of the item from “unread” to “read”.

11. The system of claim 9, wherein the user is presented with the option to keep the state an item as “unread”, and wherein, when the user does instruct the embedded device to keep the sate of the item as “unread”, the embedded device sends instructions to the aggregator to switch the state of the item from “read” to “unread”.

12. The system of claim 10, wherein before the embedded device sends instructions to the aggregator to switch the state of the item from “unread” to “read”, the embedded device presents the user with the option to keep the state of the item as “unread”, and wherein, when the user instructs the embedded device to keep the state of the item as “unread”, the embedded device does not send instructions to the aggregator to switch the state of the items from “unread” to “read”, thereby maintaining the state of the item as “unread” on the aggregator.

13. The system of claim 2 further comprising an EAM residing on the embedded device, wherein the EAM includes:
a) a communication module for managing communication with the aggregator and downloading data from the aggregator;
b) a document parser module for parsing the data downloaded by the communication module; and
c) a display module for formatting and displaying the data parsed by the document parser module.

14. The system of claim 13 further comprising: a) a storage module for storing data handled by the communication module, document parser module and display module, and b) a user settings module to control the behavior of the EAM.

15. The system of claim 13, further comprising an API residing on the aggregator, wherein the API includes:
a) a feed query module for returning to the EAM a list of feeds managed by the aggregator along with attributes associated with each feed;
b) a feed retrieval module for returning to the EAM feeds and their associated unread items;

16. The system of claim 15 further comprising an item retrieval module for returning the content of each unread item along with its associated attributes.

17. The system of claim 13 wherein the communication module of the EAM utilizes an embedded network connection to access aggregator via the Internet.

18. The system of claim 17 wherein the embedded network utilizes TCP/IP.

19. The system of claim 18 wherein the embedded network is a cellular phone network.

20. A method of accessing information with an embedded device, the method including the steps of:
a) gathering information on an aggregator;
b) downloading said information onto the embedded device;
c) whenever information is accessed by the user on an aggregator the embedded device, providing an update to reflect that the information has been accessed by the user on the aggretor;
d) whenever information is accessed by the user on an embedded device, notifying the aggregator that said information has been accessed by the user on the embedded device.
